(19) United States
(12) Patent Application Publication
(10) Pub. No.: US 2021/0114494 A1
(43) Pub. Date: Apr. 22, 2021

(54) Portable Neck Support

(71) Applicant: Antonio Hernandez, Canyon Lake, TX (US)

(72) Inventor: Antonio Hernandez, Canyon Lake, TX (US)

(21) Appl. No.: 16/974,136

(22) Filed: Oct. 16, 2020

Related U.S. Application Data
(60) Provisional application No. 62/973,724, filed on Oct. 21, 2019.

(51) Int. Cl. B60N 2/818; B60N 2/882; B60N 2/874; B60N 2/885

(52) U.S. Cl. CPC B60N 2/818; B60N 2/885; B60N 2/874; B60N 2/882

(57) ABSTRACT

A portable neck support which includes height and side adjustments which is removably attached to a seat or other support apparatus.

### BACKGROUND OF THE INVENTION

### 1 Field of the Invention

This invention relates to a portable neck support.

### 2. Description of the Prior Art

The traveling public knows full well how awkward and uncomfortable it is to attempt to sleep within the confines of the provided seat. There is no real support for your head and neck so in the unlikely event a person does manage to fall asleep, they will either fall forward into the chair in front or worse, to the side into another passenger. Seats have been redesigned to provide for additional cushion support to the right and left of the neck area, however these improvements have not helped the sleeping experience.

As early as 1953 in R. L. Rising's Headrest for Automobiles, U.S. Pat. No. 2,642,927, a need was recognized for neck support when traveling in a moving vehicle. Ms. Rising's neck support was primarily utilized to prevent a person's head from swaying right or left and did not eliminate movement forward. Since Ms. Rising's invention, there have been other attempts to provide neck support such as U.S. Pat. No. 8,141,187, Sleepy Head's/Neck Pillow Invention, issued to Alice Jean Schwingendorf, et al; U.S. Pat. No. 8,239,987, Headrest Pillow and Eye Mask Attachment for Neck Pillow, issued to Eric Sharp; U.S. Patent Publication 2015/0257538, Attachable Headrest with Eye Cover, issued to Alejandra Maria MacDougall, et al; U.S. Pat. No. 9,566,885, Head Restraint, issued to Ben Cohen Gazit; U.S. Pat. No. 9,751,438, Seat Resting Apparatus, issued to Mario Gene Dunham; and U.S. Patent Application Number 2017/0320413, Adjustable Head and Neck System, issued to Travis Lyn Knapp. Each of these inventions attempted to solve the issue of providing adequate neck support in a more comfortable way. Knapp's invention retrained the head from moving forward through use of a strap but only attached to the user and not the seat in which the user was sitting. Dunham's solution was to attach the neck support to a seat and a user utilizing a system of straps. Included with the Dunham neck support was a pillow to provide comfort to the user's head. Gazit's neck support maintained the strap system of attaching the support to a seat but added side panels to reduce movement of a user's head left or right. MacDougall's neck support increased the size of the pillow behind the head, however eliminated the use of side panels and relied only on straps to prevent a user's head from swaying left or right. Sharp's resolution of the support/comfort paradigm in neck supports relied on basically utilizing a neck ring. A user's head can move in any direction limited only to size of the neck ring. While comfortable, support is clearly lacking in Sharp's neck support. Finally, in Schwingendorf, et al, the solution disclosed consisted of a bone structure inside the neck pillow. While Schwingendorf, et al, improved support, comfort is definitely sacrificed.

One need only ask his or herself, which of the above inventions have they seen when traveling on an airplane. The answer is none. You will see use of a basic neck ring which while comfortable, lacks in support. Comfort clearly drives a person's choice of neck support and the current state of innovation in regards neck supports as recited above might provide more neck support but are not used because they lack comfort. Additionally, when it comes to neck supports, one size does not fit all. Limitations of previous neck supports prevented adjustments to tailor the support to each user. It is therefore the objectives of the invention disclosed herein, designed by a flight attendant, to solve the deficiencies of the previously used neck supports.

### SUMMARY OF THE INVENTION

It is, therefore, an object of the present invention to provide a portable neck support that will attach to the top of a seat, in a shape that is designed to adequately cushion and support of the cervical spine while permitting vertical but not horizontal movement of said support. The portable neck support of the present invention is designed to provide users the ability to comfortably sleep in an upright, seated position by reducing excess stress on the cervical spine. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an illustration of the neck support in use, attached to a seat.

FIG. 2 depicts the neck support adjusted fully upward.

FIG. 2A illustrates the neck support adjusted fully downward.

FIG. 3 is a front and rear view of the neck support with side panels collapsed.

FIG. 4 is a front, rear and side view of the neck support with side panels opened.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

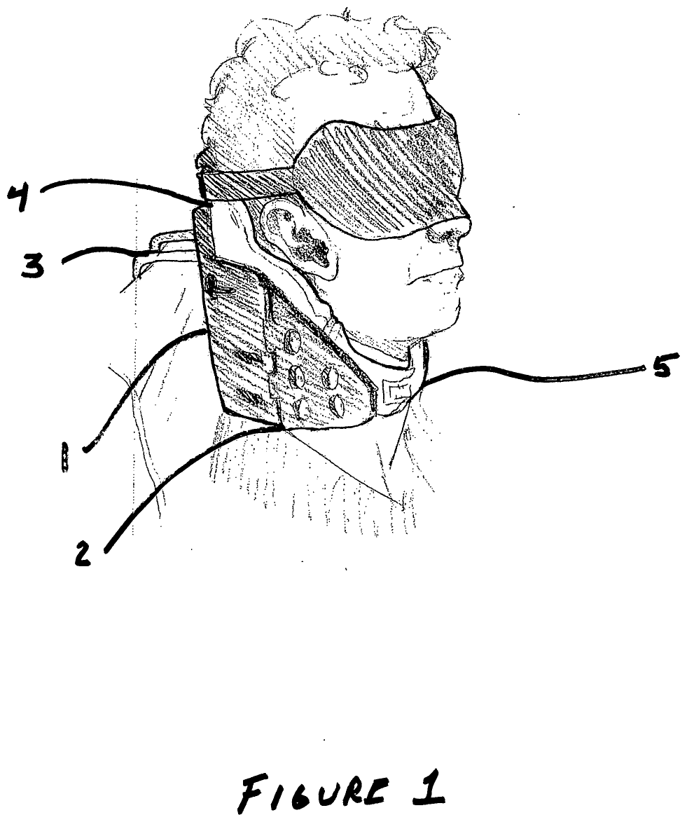

As can be seen in FIG. 1, the neck support comprises a rear support panel [1] which in general fits against the seat and extends forward around a person's neck; a side panel [2]; seat attachment means [3]; a cushion [4] attached to the back support [1] and side panel [2]; and a strap [5] which attaches around the front of the neck of a user. The cushion [4] can be made of any material such as that type of material used to fill a pillow. Although FIG. 1 depicts only the left side panel however, an identical right panel is also included in the neck support. While other means such as straps could be used for the seat attachment means [3], FIG. 1 depicts the use of hooks [3] which extend from the front to the rear of a seat. While any number of hooks could be used, FIG. 1 depicts the use of two hooks [3]. While not necessary for functionality of the neck support, the seat attachment means [3] can be foldably attached to the rear support panel [1] which will allow ease of storage when the neck support is not is use.

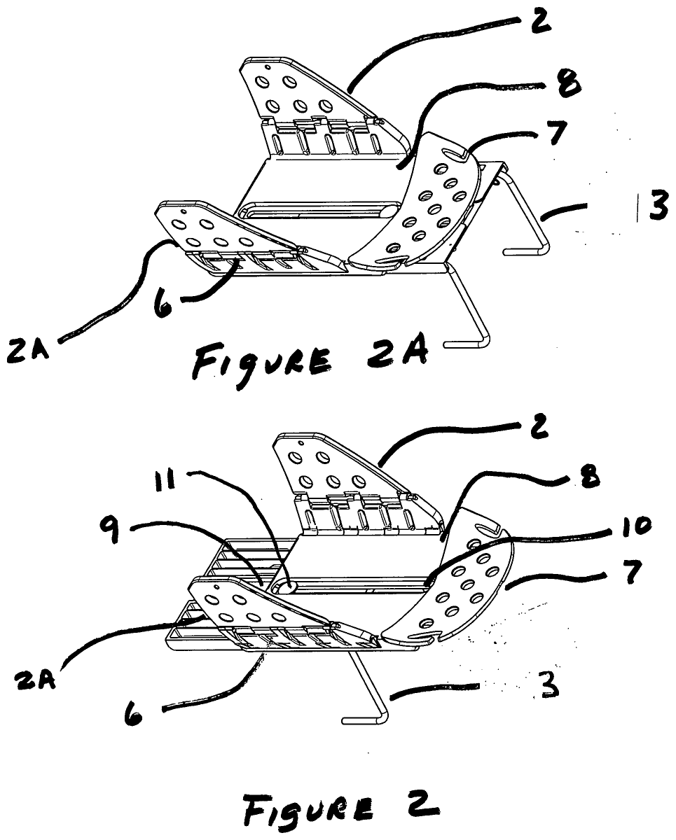

FIG. 2 depicts both the left [2] and right side panel [2A], as well as the rear support panel [1] and the seat attachment means [3]. As can be seen in FIG. 2, the side panels [2] and [2A] are flexibly attached to a height adjustment panel [8] which includes a head support panel [7]. Although any flexible attachment between the side panels [2] and the height adjustment panel [1] can be used so long as such attachment allows side panels to fold inward or outward for custom neck adjustment, FIG. 1 depicts a two hinge approach [6]. The height adjustment panel [8] is movably attached to the rear support panel [1] to permit movement up or down. FIG. 2A illustrates the height adjustment panel [8] adjusted to a fully down position while FIG. 2B depicts the height adjustment panel [8] in the up position. While any conventional means can be utilized to allow the height adjustment panel [8] to move up or down along the rear support panel [1], FIG. 2 depicts use of interconnecting channels [9] and [10] within the rear support panel [1] and height adjustment panel [8] secured together through use of pin [11].

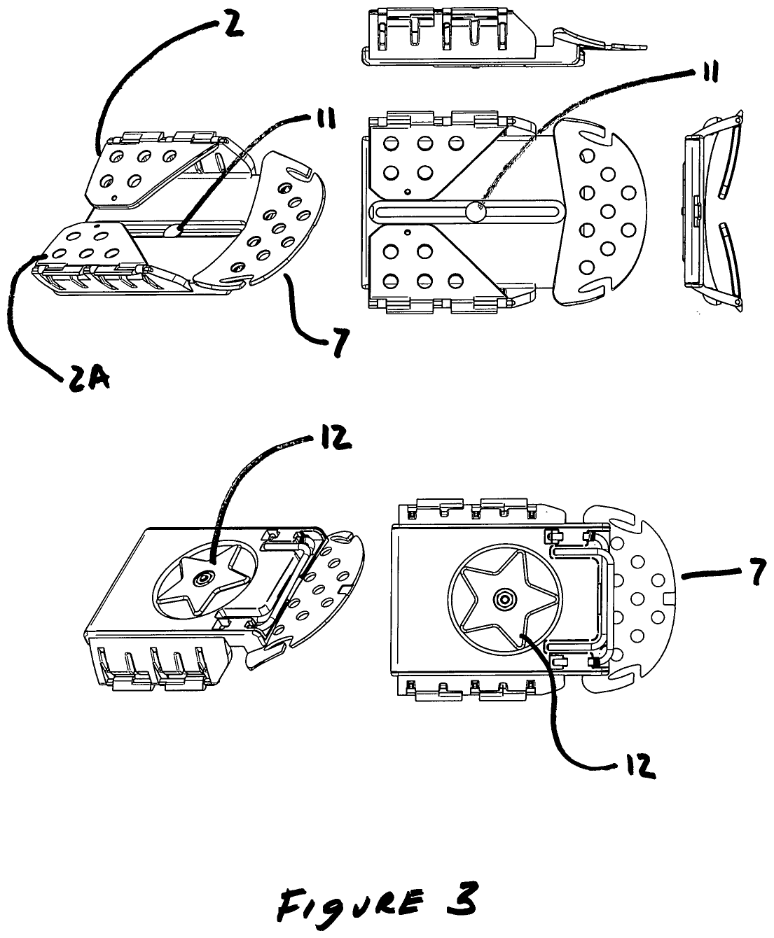

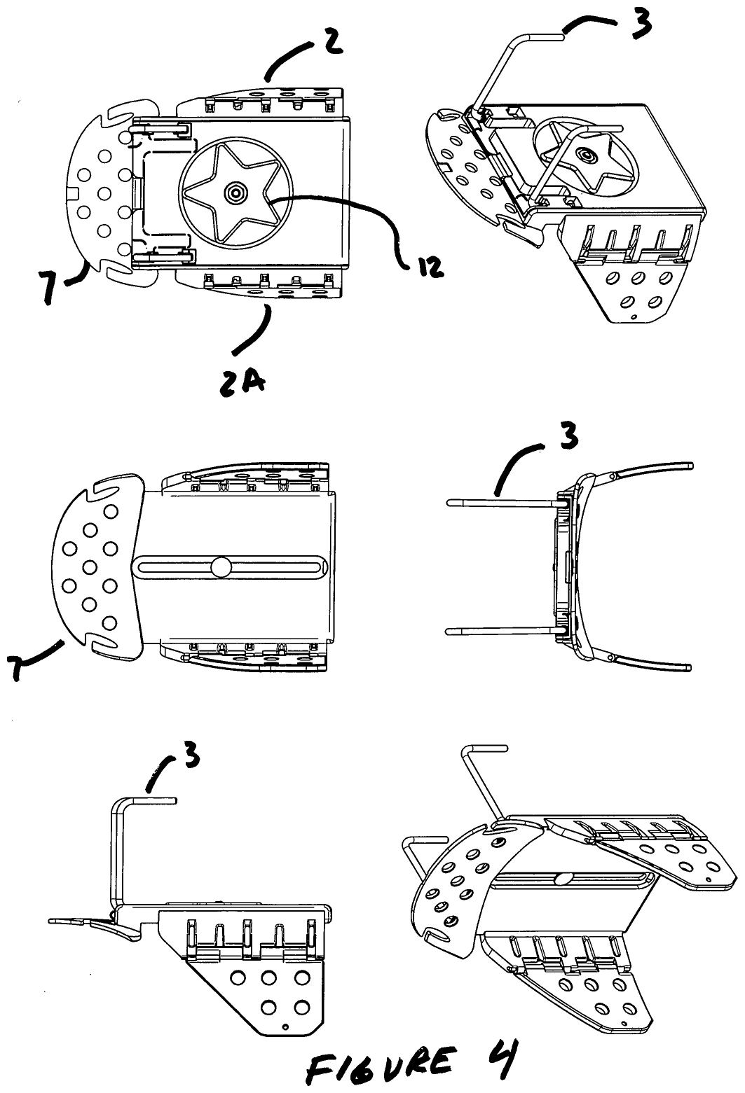

FIG. 3 illustrates the rear side panels [2] and [2A] folded inward for ease of storage. FIG. 3 also illustrates the height adjustment panel [8] tightening apparatus [12]. Once the height adjustment panel [8] is adjusted up or down as seen in FIGS. 2 and 2A, the tightening apparatus [12] is rotated clockwise to secure the adjusted position. To allow movement of the height adjustment panel [8], the tightening apparatus [12] is rotated counter-clockwise. Also seen in FIG. 3 is the seat attachment means [3] folded inward, again for ease of storage. FIG. 4 depicts the neck support with side panels [2] and [2A] and seat attachment means [3] folded outward for actual used of the neck support by a person.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A neck support comprising a rear support panel; a left and right side panel secured to the rear support panel; a cushion secured to the inner surfaces of the rear support panel and left/right side panels; a strap connecting one side of the cushion to the other side along the front of a person's neck; a head support panel; and a means to attach the neck support to a seat or other supporting apparatus.

2. The neck support of claim 1 wherein the connection between the left/right side panels and rear support panels is flexible.

3. The neck support of claim 1 wherein the connection between the left/right side panels and the rear support panel is a hinge.

4. The neck support of claim 1 wherein the seat attachment means are hooks which fit along the top of a seat of other supporting apparatus.

5. A neck support comprising a rear support panel; a left and right side panel flexibly secured to the rear support panel using a hinge; a cushion secured to the inner surfaces of the rear support panel and left/right side panels; a strap connecting one side of the cushion to the other side along the front of a person's neck; a head support panel; and hooks used to attach the neck support to a seat or other supporting apparatus.

6. The neck support of claim 6 wherein a height adjustment panel is movably attached to the rear support panel.

7. The neck support of claim 6 wherein a height adjustment panel is attached to the rear support panel using interconnected channels secured through by a pin.

8. The neck support of claim 6 wherein a height adjustment means is attached to the rear support panel using interconnected channels secured by a pin which can be tightened to hold the height adjustment panel in place.

9. The neck support of claim 6 wherein the hooks can be folded against the back of the rear support panel.
